(19) United States
(12) Patent Application Publication
(10) Pub. No.: US 2013/0068252 A1
(43) Pub. Date: Mar. 21, 2013

(54) METHOD AND APPARATUS FOR CLEANING FILTERS

(71) Applicants: Duane Ager, Oxford (GB); Timothy Goodall, Oxford (GB); William Pope, Oxford (GB)

(72) Inventors: Duane Ager, Oxford (GB); Timothy Goodall, Oxford (GB); William Pope, Oxford (GB)

(73) Assignee: Microbial Solutions Limited, Yarnton (GB)

(21) Appl. No.: 13/591,668

(22) Filed: Aug. 22, 2012

Related U.S. Application Data
(63) Continuation of application No. PCT/GB2011/000257, filed on Feb. 24, 2011.

(30) Foreign Application Priority Data
Feb. 25, 2010 (GB) 1003202.7

(51) Int. Cl. B01D 29/66; B01D 29/64

(52) U.S. Cl. CPC B01D 29/66; B01D 29/6407
USPC 134/9; 134/15; 15/347

(57) ABSTRACT

There is described an apparatus for cleaning a filter cloth, comprising: a cleaning station comprising a gas flow device and a support surface defining an aperture; and a collection device positioned below the aperture for receiving material removed from the filter cloth; wherein the gas flow device is configured to provide a flow of gas through an area of filter cloth located above the aperture so as to remove material from the filter cloth and direct it into the collection device.

### TECHNICAL FIELD

This invention relates to method and apparatus for cleaning filters. In particular it relates to methods and apparatus for cleaning filter cloths used in the filtering of metal working fluids.

### BACKGROUND ART

Metal working fluids (MWF) are used as lubricants and coolants in metal cutting and grinding and in drilling operations in industrial manufacturing, for example in automotive engine, transmission and stamping plants. Most MWFs are reused through a delivery and return system over a period of time. During this period the MWF can collect metal particles, dirt and other contaminants. These contaminants need to be regularly removed from the MWF to ensure that the MWF can still work effectively when the fluid is reused.

One method for removing these contaminants from the MWF before it is reintroduced back into the system or before the MWF under goes further processing for disposal, treatment or recycling and the like, is to pass the MWF through a filter. The material that is too large to pass through the filter is collected on the surface of the filter. A filter cloth is typically used for such an operation. Eventually sufficient material is collected on the filter, such that the performance of the filter is compromised and is no longer suitable to continue to be used. The filter cloth then needs to be replaced and disposed of or cleaned if it is to be reused.

Typical methods for cleaning filter cloths involve passing the cloth through a liquid bath, and using a surfactant to remove the material from the filter cloth or scraping of metal particles from the surface of the filter cloth. The material that collects on the filter cloth can be or can include particles—such as solid particles, liquid particles or emulsions or combinations thereof. For example, the material can be or can include emulsions and/or droplets that are substantially immiscible or only partially miscible with water—such as oil and/or oil/water droplets.

The object of the present invention is to provide an apparatus for removing material from a filter cloth which will allow the filter cloth to be reused.

### DISCLOSURE OF THE INVENTION

In one aspect, there is provided an apparatus for cleaning a filter cloth, comprising: a cleaning station comprising a gas flow device and a support surface defining an aperture; and a collection device positioned below the aperture for receiving material removed from the filter cloth; wherein the gas flow device is configured to provide a flow of gas through an area of filter cloth located above the aperture so as to remove material from the filter cloth and direct it into the collection device.

In one embodiment, the apparatus further comprises a movement device configured to move the filter cloth past the aperture in the cleaning station.

In one embodiment, the collection device comprises a directing device configured to receive material removed from the filter cloth and direct the material into a collection chamber and/or wherein the collection device comprises a collection chamber for containing the material removed from the filter cloth.

In one embodiment, the gas flow device is a gas blowing device positioned above the support surface and arranged to blow gas through the filter cloth and into the aperture and/or wherein the gas flow device is a gas suction device positioned below the support surface and arranged to draw gas through the filter cloth and aperture.

In one embodiment, the apparatus further comprises a support structure for holding a supply of filter cloth.

In one embodiment, the apparatus further comprises a second support structure on which the cleaned filter cloth can be stored after having being moved past the cleaning station.

In one embodiment, the apparatus further comprises a movement device control system having a sensor system for detecting the amount of cleaned filter cloth stored on the second support structure.

In one embodiment, the apparatus further comprises a brush located before the gas flow device and arranged to brush material from the cloth surface.

In one embodiment, the support surface comprises plates spaced apart to define the aperture.

In a second aspect, there is provided a method of cleaning a filter cloth comprising: passing a used filter cloth through a cleaning station comprising a gas flow device and a support surface defining an aperture; operating the gas flow device to direct a flow of gas though an area of the cloth above the aperture; and collecting the material removed from the cloth by the gas flow in a chamber below the aperture.

In one embodiment, the step of operating the gas flow device comprises blowing gas through the filter cloth or sucking gas flow through the filter cloth.

In one embodiment, the method further comprises brushing the filter cloth to remove material from the filter cloth before passing the filter cloth through the cleaning station.

In one embodiment, the method further comprises rolling the filter cloth onto a holder after passing through the cleaning station and/or stacking the filter cloth after passing through the cleaning station.

In one embodiment, the method further comprises using the apparatus as described herein.

In a further aspect, there is provided the use of an apparatus as described herein for cleaning a filter cloth.

In a further aspect, there is provided an apparatus or a method substantially as described herein and with reference to the accompanying description and drawings.

Further aspects of the invention will be apparent from the following description.

### BRIEF DESCRIPTION OF THE DRAWINGS

The invention will now be described by way of example with reference to the accompanying drawings:

FIG. 1 shows a schematic view of one embodiment of the invention;

FIG. 2 shows a schematic view of an embodiment of the invention; and

FIG. 3 shows a schematic view of an embodiment of the invention.

### MODE(S) FOR CARRYING OUT THE INVENTION

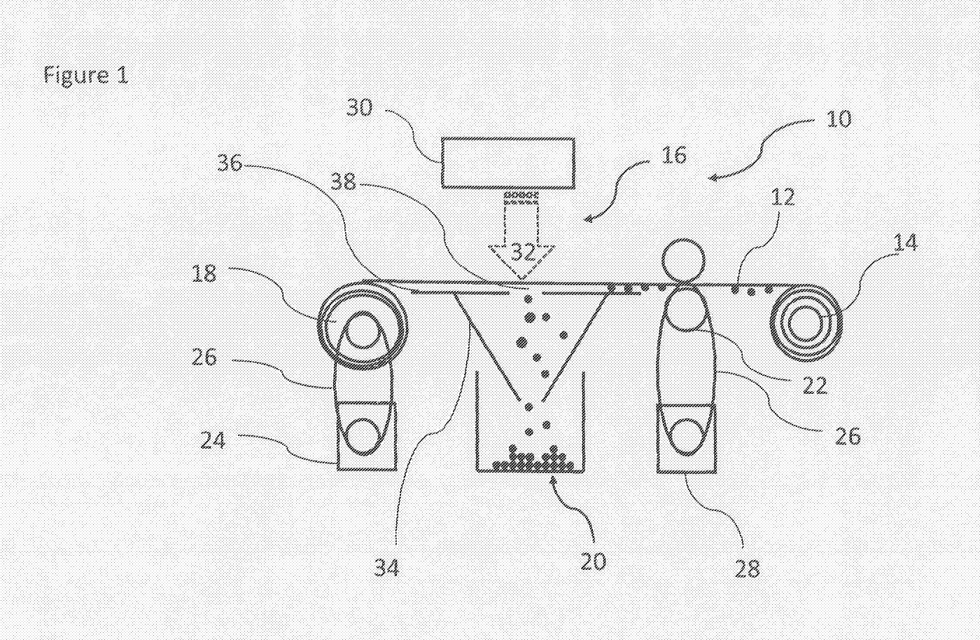

Referring to FIG. 1 in one embodiment of the invention the apparatus 10 for cleaning a filter cloth 12 comprises a first support structure 14 which holds a roll of used filter cloth to be cleaned. A cleaning station 16 is located adjacent the first support structure 14. A second support structure 18, for receiving the cleaned filter cloth 12 onto a second roll, is positioned on the opposite of the cleaning station from the first support structure. A collection device—such as a collection chamber 20—for receiving the material removed from the dirty filter cloth is positioned between the two support structures 14, 18 underneath where the filter cloth travels. The material that is removed from the dirty filter cloth and is collected in the collection device is referred to herein as ‘debris’.

The first support structure 14 holds a roll of the used filter cloth 12 that is to be cleaned. The filter cloth 12 is directed from the roll through two guide rollers 22 which direct the filter cloth through the cleaning station 16. After passing through the cleaning station 16 the filter cloth 12 is collected onto a second support structure 18. The second support structure 18 is connected to a motor 24 by a drive belt 26. As the motor 24 is driven it causes the second support structure 24 to rotate and when the filter is connected to the second support structure, draw the filter cloth from the roll of dirty filter cloth 12 through the cleaning station 16 and onto the second structure 18. The guide rollers 22 can also be connected to second motor 28 by a drive belt 26. As the second motor 28 is driven it causes the bottom roller of the pair of guide rollers 22 to rotate. This assists in pulling the filter cloth 12 from the roll and directing the filter cloth 12 to the cleaning station 16.

The apparatus can comprise a motor control system for controlling the speed of the motor and having a sensor system. A sensor is positioned to detect the diameter of the roll of cleaned filter cloth that is stored on the second support structure. The sensor can send a signal to a control module of the motor control system dependant on the diameter of the roll of clean cloth. The control module adjusts the speed of the motor dependant on the amount of clean cloth present to keep the speed of the cloth moving through the cleaning station constant.

The cleaning station 16 comprises an air flow device—such as a gas compressor 30 or any alternative device that is suitable to provide a gas flow 32 through the filter cloth as the filter cloth moves through the cleaning station 12 so as to remove material from the filter cloth and direct it into the collection device. In one embodiment the gas is air. In another embodiment, the gas compressor is an air compressor. The gas compressor 30 is configured to direct a gas flow transversely to the movement of the filter cloth so that the compressed gas blows from above the filter cloth from the clean side through to side on which the filtered material was deposited. The pressure of the gas applied is sufficient to dislodge the material that has collected on the filter.

As used herein, the term “material” is used in broadest sense to refer to any material that has collected on the filter cloth and that can be removed in accordance with the present invention. Accordingly, the material can be or can include particles—such as solid particles, liquid particles or emulsions or combinations thereof. For example, the material can be or can include emulsions and/or droplets that are substantially immiscible or only partially miscible with water—such as oil and/or oil/water droplets.

The collection chamber 20 can be any suitable container for holding the debris, such as a bag, bin or box for subsequent disposal, treatment and/or recycling of the debris. The collection device may also include a directing device such as a funnel 34 which can be located between the chamber 20 and filter cloth 12 to contain the flow of the debris falling from the cloth and direct the debris into the chamber. Plates 36 define a support surface with an aperture 38 through which the gas compressor blows gas through to direct the material from the filter cloth 12 into the chamber 20.

The size of the filter clothes that are used in industrial machinery for metal working operations can be up to 3 m wide or more. The size of the apparatus will depend on the filter cloth to be used. It is preferred that the gas compressor will provide a flow of gas over the entire width of the filter cloth.

The roll of dirty filter cloth is loaded onto the apparatus, such that when the filter cloth 12 is drawn through the cleaning station 16 the side of the filter cloth on which the material has been deposited faces down towards the collection chamber 20. An initial length of cloth is drawn from the roll of used cloth through the cleaning station 12 and connected to the roll of the second support structure 18. The motor 24 is started and causes the second roll to rotate which draws the filter from the first roll through the cleaning station 16 on to the second roll. As filter cloth is drawn onto the second roll the sensor detects the diameter of the roll of cleaned cloth and sends a signal to the control module dependant on the diameter of clean cloth present. The control module alters the speed of the motor 24 to keep the speed of the cloth drawn through the cleaning station 16 constant. The speed of the motor will change as more cloth is drawn onto the second roll, and the diameter of the roll increases.

As the filter cloth 12 is drawn through the cleaning station 16 the gas compressor 30 is started and applies a stream of compressed gas 32 to an area of filter cloth 12 that is located beneath the compressor and above the aperture 38 in the plates 36. The motor is operated to ensure that the speed in which is filter cloth moves through the cleaning station provides sufficient time for an area of the filter cloth to be exposed to the gas flow from the compressor to dislodge the debris from the cloth.

The flow of gas 32 is stronger enough to dislodge the material from the cloth 12 which can then fall into the chamber 20 where the debris can be collected and stored for subsequent disposal, treatment and/or recycling.

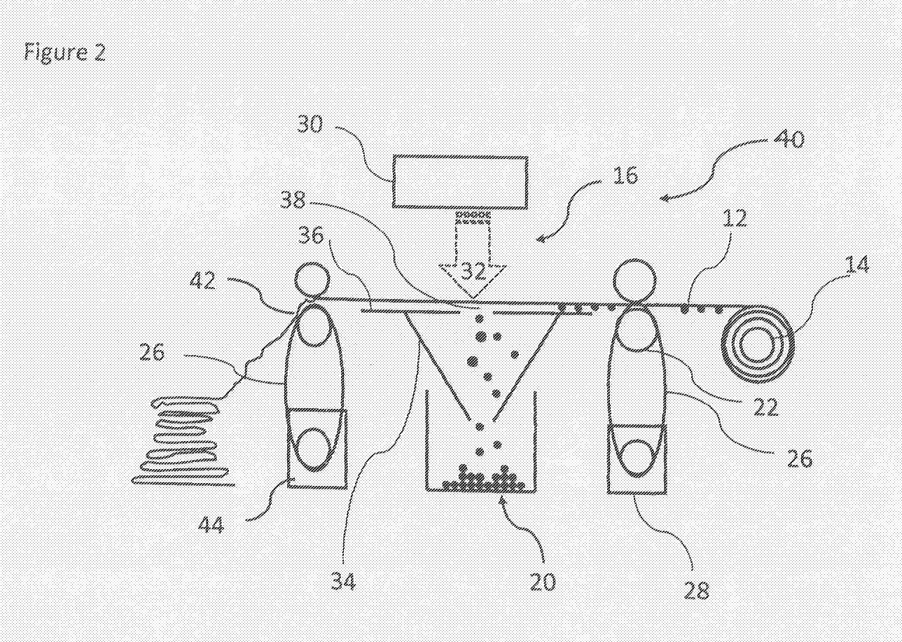

FIG. 2 shows a further embodiment of the invention. The apparatus 40 comprises a first support structure 14 which holds the roll of used filter cloth 12 to be cleaned. A cleaning station 16 is located adjacent the first support structure 14. The apparatus also comprises a collection chamber 20 for receiving the removed material from the used filter cloth 12.

The first support structure 14 holds a roll of used filter cloth 12 to be cleaned. The filter cloth 12 is directed from the roll through a first set of guide rollers 22 which direct the filter cloth through the cleaning station 16. After passing through the cleaning station 16 the filter cloth 12 is directed through a second set of guide rollers 42 and the cleaned cloth is stacked for reusing. The second set of rollers 42 is driven by a motor 44 located beneath the lower roller 42 and connected to the lower roller by a drive belt 26. As the motor 44 is driven to rotate the roller, it causes the roller to draw the filter cloth 12 from the first roll through the first set of guide rollers 22 and through the cleaning station 16 and then through the second set of guide rollers 42, where the cleaned cloth can then be gathered. The first set of guide rollers 22 can be connected to a second motor 28 to assist in pulling the filter cloth 12 from the roll and directing it through the cleaning station 16.

As described above the cleaning station 16 comprises a gas compressor 30 which is arranged to provide a gas flow 32 through the filter cloth 12 as the filter cloth 12 is drawn through the cleaning station 16. The gas compressor 30 directs gas from above the filter cloth and through the cloth from the clean side through to the used side. The force of gas is sufficient to dislodge the material that has collected on the filter cloth 12 and direct the material into the collection chamber 20.

A funnel 34 is located between the chamber and filter cloth to contain the flow of the debris falling from the cloth and direct the debris into the chamber 20. The funnel 34 comprises inclined walls and plates 36 defining an aperture 38 through which the gas compressor 30 blows gas through.

The roll of used filter cloth 12 is loaded onto the apparatus 40. When the roll of used filter cloth 12 is loaded onto the apparatus it is arranged such that when the filter cloth 12 is drawn through the cleaning station 16 the dirty side of the cloth 12 faces down towards the collection chamber 20. An initial length of cloth is drawn from the first roll, and through the first set of guide rollers 22, the cleaning station 61 and then through the second set of guide rollers 42. The motor 44 is started and causes the roller 42 to rotate which draws the filter from the first roll through the first set of guide rolls 22 and cleaning station and then through second guide rollers 42 to be collected from the apparatus.

As the filter cloth 12 is drawn through the cleaning station 16 the gas compressor 30 is started and blows gas through an area of filter cloth that is located beneath the gas compressor 30 and above the chamber 20. The motor is operated to ensure that the speed of which is filter cloth moves through the cleaning station provides sufficient time for an area of the filter cloth to be exposed to the force of gas from the compressor to dislodge the debris from the cloth.

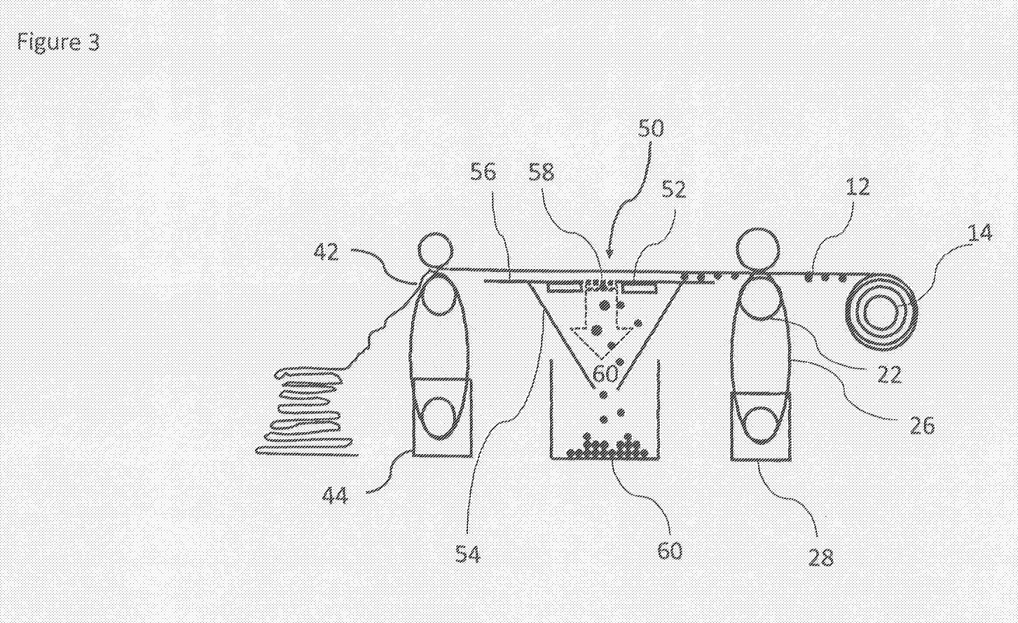

FIG. 3 shows one embodiment of the invention in which the cleaning station 50 comprises a suction device 52. As the filter cloth 12 is moved through the cleaning station 50 the material on the filter cloth 12 can be sucked from the filter cloth 12. The suction device 52 can be located within the funnel 54 beneath the plates 56 which define an aperture 58 through which the material can drop from the filter cloth 12 into the chamber 60. The suction device 52 creates a gas flow 62 that draws the material from the filter cloth 12 as it passes over the aperture 58. The force of the suction is sufficient to pull the material off the filter cloth 12 such that it is drawn into the collection chamber 60, where the debris can be disposed, removed or recycled.

The motors 44 and 28 are operated to ensure that the speed at which the filter cloth 12 is pulled through the cleaning station 50 provides sufficient time for an area of the filter cloth to be exposed to the force of gas from the suction device 52 to draw the material from the cloth and into the collection chamber 60.

Brushes and/or scrapers can be located on the apparatus to loosen the material from the filter cloth before the filter cloth is exposed to the suction of the gas pressure device. The brushes or scrapers help dislodge the material and partially remove the material collected on the cloth making it easier for the gas pressure device or suction device to remove the material from the filter cloth.

The brushes can be positioned after the first set of guide rollers such that the bristles of the brush interact with the material deposited on the filter cloth. The scraper can be positioned so that the blade of the scraper interacts with the material deposited on the filter cloth.

Further aspects of the present invention are set forth below in the following numbered paragraphs:

1. An apparatus for cleaning a filter cloth, comprising:
a support structure for holding a supply of filter cloth;
a cleaning station comprising an air flow device and a support surface defining an aperture;
movement device to move the filter cloth from the support structure past the aperture in the cleaning station; and
a collection chamber positioned below the aperture for receiving particles removed from the filter cloth;
wherein the air flow device is configured to provide a flow of air through an area of filter cloth located above the aperture so as to remove particles from the filter cloth and direct them into the collection chamber.

2. An apparatus according to paragraph 1, wherein the air flow device is an air blowing device positioned above the support surface and arranged to blow air through the filter cloth and into the aperture.

3. An apparatus according to paragraph 1, wherein the air flow device is an air suction device positioned below the support surface and arranged to draw air through the filter cloth and aperture.

4. An apparatus according to paragraphs 1, 2 or 3, comprising a second support structure on which the cleaned filter cloth can be stored after having been moved past the cleaning station.

5. An apparatus according to paragraph 4, comprising a movement device control system having a sensor system for detecting the amount of cleaned filter cloth stored on the second support structure.

6. An apparatus according to any preceding paragraph, further comprising a brush located before the air flow device and arranged to brush particles from the cloth surface.

7. An apparatus according to any preceding paragraph, comprising a funnel located below the aperture so as to direct to the particles from the cloth to the chamber.

8. An Apparatus according to any preceding paragraph, wherein the support surface comprises plates spaced apart to define the aperture.

9. A method of cleaning a filter cloth comprising:
passing a used filter cloth through a cleaning station comprising an air flow device and a support surface defining an aperture;
operating the air flow device to direct a flow of air though an area of the cloth above the aperture; and
collecting the particles removed from the cloth by the air flow in a chamber below the aperture.

10. A method according to paragraph 9, wherein the step of operating the air flow device comprises blowing air through the cloth.

11. A method according to paragraph 9, wherein the step of operating the air flow device comprises sucking air flow through the cloth filter.

12. A method according to any of paragraphs 9, 10 or 11, further comprising brushing the cloth to remove particles from the cloth before passing the cloth through the cleaning station.

13. A method according to any of paragraphs 9-12, comprising rolling the filter cloth onto a holder after passing through the cleaning station.

14. A method according to any of paragraphs 9-12, comprising stacking the filter cloth after passing through the cleaning station.

15. A method according to any of paragraphs 9-14, comprising using the apparatus as claimed in any of paragraphs 1-8.

Although the invention has been described by way of example with reference to specific embodiments of the invention, other changes can made within the scope of the invention. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant art or related fields are intended to be within the scope of the following claims.

1. An apparatus for cleaning a filter cloth, comprising:
a cleaning station comprising a gas flow device and a support surface defining an aperture; and
a separate collection device positioned below the aperture for receiving material removed from the filter cloth:
wherein the gas flow device is configured to provide a flow of gas through an area of filter cloth located above the aperture so as to remove material from the filter cloth and direct it into the separate collection device.

2. The apparatus as claimed in claim 1, further comprising a movement device configured to move the filter cloth past the aperture in the cleaning station.

3. The apparatus as claimed in claim 1, wherein the collection device comprises a directing device configured to receive material removed from the filter cloth and direct the material into a collection chamber and/or wherein the collection device comprises a collection chamber for containing the material removed from the filter cloth.

4. The apparatus as claimed in claim 1, wherein the gas flow device is a gas blowing device positioned above the support surface and arranged to blow gas through the filter cloth and into the aperture and/or wherein the gas flow device is a gas suction device positioned below the support surface and arranged to draw gas through the filter cloth and aperture.

5. The apparatus as claimed in claim 1, further comprising a support structure for holding a supply of filter cloth.

6. The apparatus as claimed in claim 7, comprising a second support structure on which the cleaned filter cloth can be stored after having been moved past the cleaning station.

7. The apparatus as claimed in claim 6, comprising a movement device control system having a sensor system for detecting the amount of cleaned filter cloth stored on the second support structure.

8. The apparatus as claimed in claim 1, further comprising a brush located before the gas flow device and arranged to brush material from the cloth surface.

9. The apparatus as claimed in claim 1, wherein the support surface comprises plates spaced apart to define the aperture.

10. A method of cleaning a filter cloth comprising
passing a used filter cloth through a cleaning station comprising a gas flow device and a support surface defining an aperture;
operating the gas flow device to direct a flow of gas though an area of the cloth above the aperture; and
collecting the material removed from the cloth by the gas flow in a separate chamber below the aperture.

11. The method as claimed in claim 10, wherein the step of operating the gas flow device comprises blowing gas through the filter cloth or sucking gas flow through the filter cloth.

12. The method as claimed in claim 10, further comprising brushing the filter cloth to remove material from the filter cloth before passing the filter cloth through the cleaning station.

13. The method as claimed in claim 10, comprising rolling the filter cloth onto a holder after passing through the cleaning station and/or stacking the filter cloth after passing through the cleaning station.

14. The method as claimed in claim 10, comprising using the apparatus as claimed in claim 1.

15. (canceled)
